(19) United States
(12) Patent Application Publication
(10) Pub. No.: US 2007/0264467 A1
(43) Pub. Date: Nov. 15, 2007

(54) Photocatalyst synthesized fiber product

(76) Inventor: Ruei-Shan Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/604,384

(22) Filed: Nov. 27, 2006

(30) Foreign Application Priority Data
May 9, 2006 (TW) 95207929

(51) Int. Cl. B32B 33/00; B01J 23/00; B05D 1/16; B32B 3/02

(52) U.S. Cl. 428/90; 502/350; 428/91; 428/97

(57) ABSTRACT

A photocatalyst synthesized fiber product includes a base material, and a plurality of photocatalyst naps. The photocatalyst naps are firmly pasted on a surface of the base material. By uniformly and densely disposing the photocatalyst naps on the surface of the base material, the area of the base material disposed by photocatalyst increases so as to increase the effect of the photocatalyst. Furthermore, due to the photocatalyst naps being attached to a surface of the base material, the color of the surface of the base material is unaffected.

### BACKGROUND OF THE INVENTION

1. Field of the Invention

The present invention relates to a photocatalyst synthesized fiber product. In particular, this invention relates to a photocatalyst synthesized fiber product with a photocatalyst nap.

2. Description of the Related Art

As industry and technology have developed, living standards have substantially improved. However, the environment has also become polluted through the development of industry and technology. Photocatalyst technology can deal with chloride-benzene organic materials, chloride-phenol compounds, cyanide, and the metal ions in water, and NOₓ, SOₓ in air. In the photocatalyst reaction process, the photocatalyst is a catalytic agent and is not consumed. Therefore, the photocatalyst is suitable for purifying air and water, deodorizing, disinfecting, and protecting household environments from dirt.

In a household, window curtains are installed to keep external light at bay. However, the window curtains directly contact the air. In order to remove pollutants from the air, an air conditioner with a photocatalyst is often installed in the household. Alternatively, the photocatalyst can be disposed on the window curtains. There are two kinds of photocatalyst window curtains. One kind allows the spraying of water including the photocatalyst on the window curtain cloth. However, the photocatalyst is not easily attached to the window curtain cloth, and the quantity of the photocatalyst attached to the window curtain cloth is small and unbalanced. Therefore, the functions of the photocatalyst, such as decomposing pollutions, deodorizing, and disinfecting, are not as efficient as they could be. The second method soaks the window curtain cloth in the photocatalyst solution to fully dispose the photocatalyst on the window curtain cloth. The result is better however, the photocatalyst easily drips off the window curtain cloth, and the color of the soaked window curtain cloth deteriorates.

### SUMMARY OF THE INVENTION

One particular aspect of the present invention is to provide a photocatalyst synthesized fiber product. The photocatalyst synthesized fiber is attached firmly, uniformly and densely on the surface of the photocatalyst synthesized fiber product. The color of the photocatalyst synthesized fiber product remains unaffected. The area upon which the photocatalyst is disposed on increases so as to increase the effect of the photocatalyst.

The photocatalyst synthesized fiber product includes a base material, and a plurality of photocatalyst naps. The photocatalyst naps are pasted on a surface of the base material. On the naps of the photocatalyst naps, the photocatalyst is fully disposed. The photocatalyst of the photocatalyst naps is firmly disposed on the surface of the naps, and the photocatalyst naps are firmly pasted on the base material and are uniformly and densely disposed on the base material. The color of the base material is unaffected by the naps. The photocatalyst naps increase the area of the photocatalyst reaction to enhance the function of the photocatalyst.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the photocatalyst synthesized fiber product of the present invention;

FIG. 2 is a schematic diagram of the photocatalyst nap of the present invention;

FIG. 3 is a schematic diagram of the first embodiment of the present invention;

FIG. 4 is a schematic diagram of the second embodiment of the present invention; and

FIG. 5 is a schematic diagram of the third embodiment of the present invention.

### DETAILED DESCRIPTION OF THE PREFERRED EMBODIMENTS

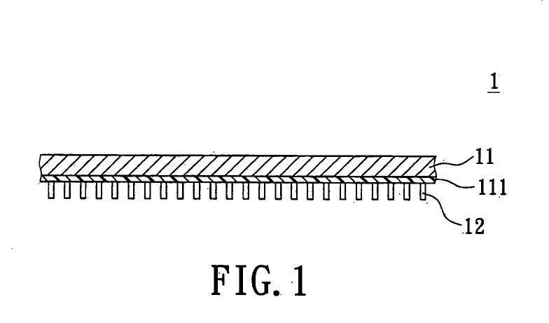

Reference is made to FIG. 1. The photocatalyst synthesized fiber product 1 includes a base material 11, and a plurality of photocatalyst naps 12. The photocatalyst naps 12 are uniformly and densely pasted on the base material 11. On the surface of the base material, an adhesive layer 111 is coated to firmly paste the photocatalyst naps 12 on the surface of the base material 11.

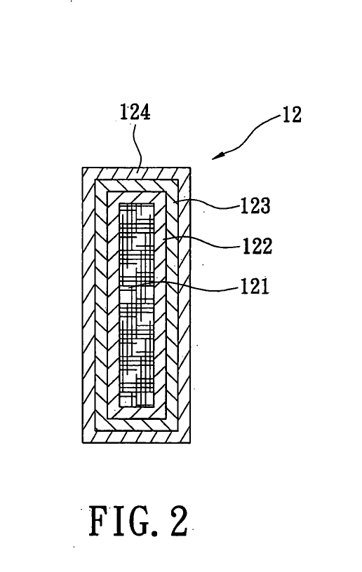

Reference is made to FIG. 2. The photocatalyst nap 12 includes a nap 121, a layer of mixing agent which is mixed by antistatic agent and dispersant 122, a layer of crosslinking agent 123, and a layer of photocatalyst 124. The nap 121 can be a synthesized fiber, such as nylon fiber, Dacron fiber or acrylic, or a compound fiber that is compounded by the synthesized fiber and natural fiber, such as wool fiber or cotton fiber. The mixing agent mixed by antistatic agent and dispersant 122 attaches to the surface of the nap 121. The crosslinking agent 123 is disposed on an outside of the mixing agent mixed by antistatic agent and dispersant 122 and disposed on the surface of the nap 121. The photocatalyst 124 is attached on the crosslinking agent 123 and disposed on the surface of the nap 121. The crosslinking agent 123 is firmly combined with the mixing agent mixed by antistatic agent and dispersant 122 and the photocatalyst 124. Therefore, the photocatalyst 124 is firmly attached to the naps so that the layer of the photocatalyst 124 is firmly attached on the surface of the photocatalyst naps 12.

The photocatalyst naps 12 are attached to a surface of the base material 11. Therefore, another surface of the base material 11 maintains its original appearance and is unaffected by the photocatalyst. The photocatalyst naps 12 makes the area of the base material 11 disposed by the photocatalyst naps 12 increase. Therefore, the reaction area of the photocatalyst 124 increases to enhance the function of the photocatalyst 124. The photocatalyst synthesized fiber is firmly attached to the surface of the photocatalyst synthesized fiber product 1, and is uniformly and densely disposed. The original color of the photocatalyst synthesized fiber product 1 is unaffected, and the reaction area of the photocatalyst 124 increases so as to enhance the function of the photocatalyst 124.

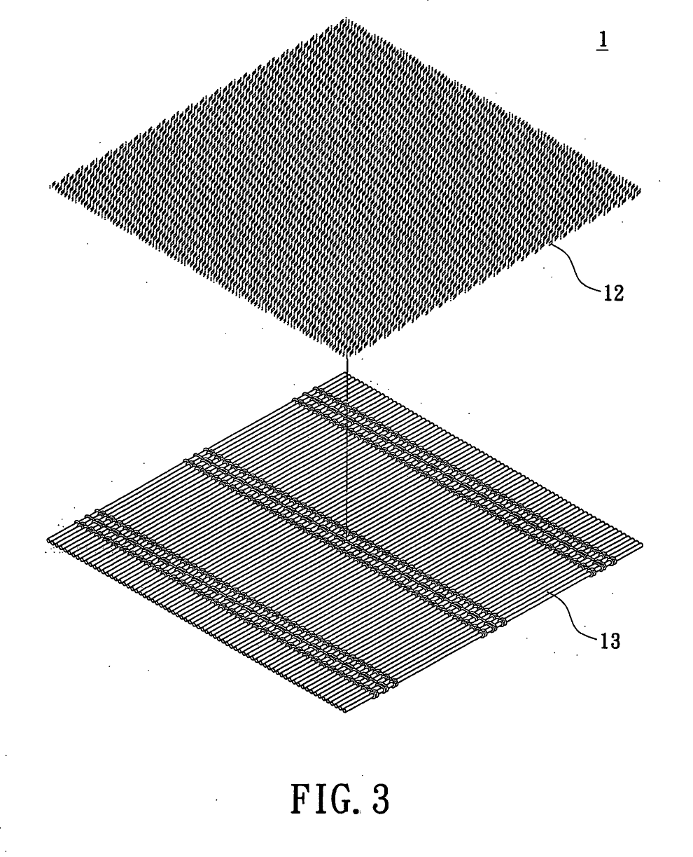

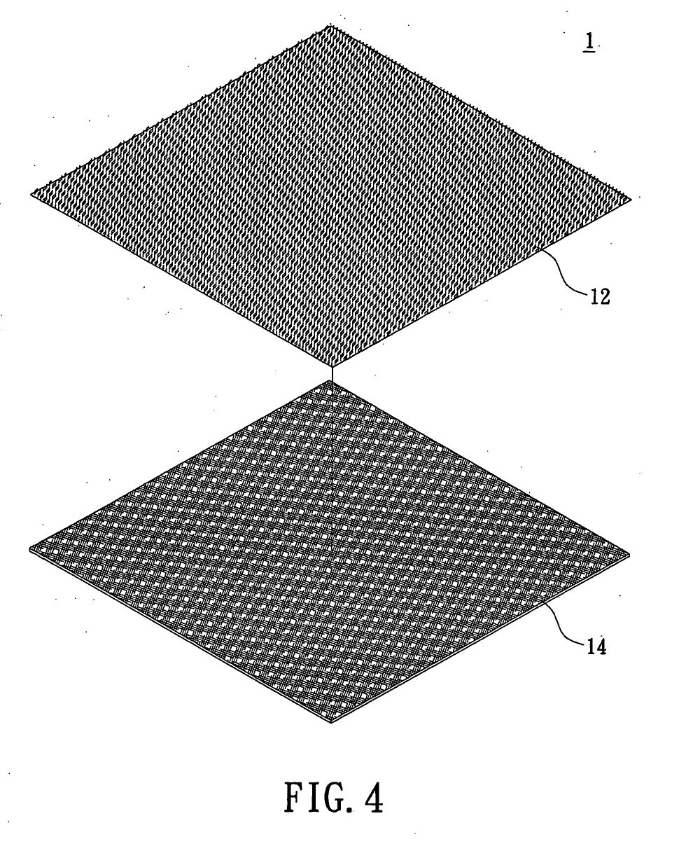

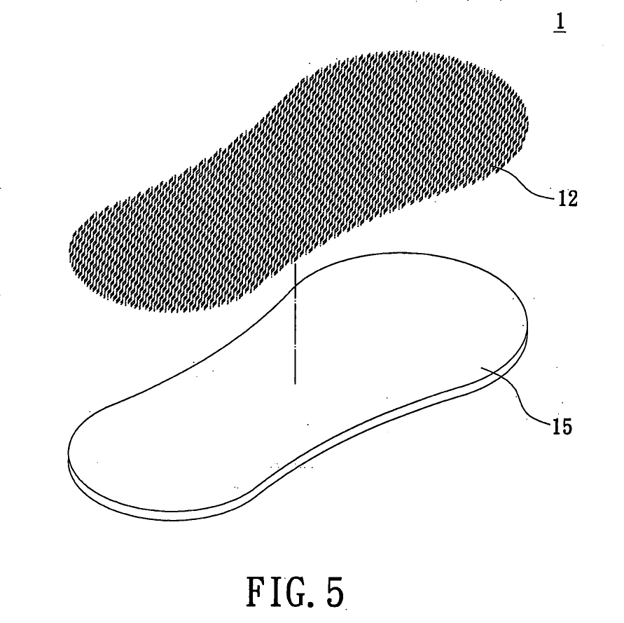

The photocatalyst synthesized fiber product 1 can be applied in many aspects, such as shown in FIGS. 3, 4 and 5. The base material 11 can be a bamboo curtain 13, a car sunshade pad 14, or a shoe pad 15, and is uniformly and densely disposed via a plurality of photocatalyst pads 12. Thereby, the bamboo curtain 13, the car sunshade pad 14, and the shoe pad 15 achieve the functions of the photocatalyst—including purifying air and water, as well as deodorizing and disinfecting the nearby environment. The photocatalyst synthesized fiber product 1 can also be applied to other common surfaces, such as window curtains, masks, etc. Because only one surface of the photocatalyst synthesized fiber product 1 is attached by the photocatalyst naps 12, it is more suitable for products having an outer surface and an inner surface, such as shoes or clothes. Therefore, the photocatalyst synthesized fiber product 1 can be extensively applied to everyday products to clean and comfort our daily life.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A photocatalyst synthesized fiber product, comprising:
a base material; and
a plurality of photocatalyst naps pasted on a surface of the base material, wherein each of the photocatalyst naps comprises a nap, and a layer of photocatalyst disposed on the surface of the nap

2. The photocatalyst synthesized fiber product as claimed in claim 1, wherein the surface of the base material pasted by the photocatalyst naps is coated with an adhesive agent, and the photocatalyst naps are pasted on the adhesive agent.

3. The photocatalyst synthesized fiber product as claimed in claim 1, wherein the base material is a bamboo curtain, a car sunshade pad, a shoe pad, a window curtain cloth, or a mask.

4. The photocatalyst synthesized fiber product as claimed in claim 1, wherein the photocatalyst naps further comprise a crosslinking agent disposed on the surface of the nap, and the photocatalyst is attached on the surface of the naps via the crosslinking agent.

5. The photocatalyst synthesized fiber product as claimed in claim 1, wherein the nap is a synthesized fiber.

6. The photocatalyst synthesized fiber product as claimed in claim 5, wherein the synthesized fiber is made from nylon fiber, Dacron fiber or acrylic fiber.

7. The photocatalyst synthesized fiber product as claimed in claim 1, wherein the nap is a compound fiber.

8. The photocatalyst synthesized fiber product as claimed in claim 7, wherein the compound fiber is composed of natural fiber and synthesized fiber.

9. The photocatalyst synthesized fiber product as claimed in claim 8, wherein the natural fiber is wool fiber or cotton fiber, and the synthesized fiber is nylon fiber, Dacron fiber or acrylic fiber.
